(19) United States
(12) Patent Application Publication
(10) Pub. No.: US 2011/0011538 A1
(43) Pub. Date: Jan. 20, 2011

(54) Fiber application machine with compacting roller transparent to the radiation of the heating system

(76) Inventors: Alexander Hamlyn, Ploemeur (FR); Yvan Hardy, Lorient (FR)

Correspondence Address: PATTERSON THUENTE CHRISTENSEN PEDERSEN, P.A., 4800 IDS CENTER, 80 SOUTH 8TH STREET, MINNEAPOLIS, MN, 55402-2100, US

(21) Appl. No.: 12/628,460

(22) Filed: Dec. 1, 2009

(30) Foreign Application Priority Data
Jul. 17, 2009 (FR) 09 54964

(51) Int. Cl. B32B 37/06; B32B 37/10

(52) U.S. Cl. 156/436

(57) ABSTRACT

A fiber application machine for the production of parts made of composite materials comprising a compacting roller for applying on an application surface a band of at least a resin pre-impregnated flat fiber, and a heating system able to emit a heat radiation towards the band. The compacting roller comprises a cylinder made of an elastically deformable flexible material and substantially transparent to said heat radiation.

### RELATED APPLICATION

The present application claims priority to French Application No. 09 54964 filed Dec. 1, 2009, which is incorporated herein in its entirety by reference.

### TECHNICAL FIELD

The present invention relates to a fiber application machine for the production of parts made of composite materials, and more particularly, such a machine comprising a fiber heating system and a heat-resistant compacting roller.

### BACKGROUND ART

There have been known fiber application machines, for applying, on an application surface of a male or female mold, a wide band formed of at least a ribbon-type, resin pre-impregnated flat fiber, particularly, carbon fibers pre-impregnated with a thermoplastic or thermosetting resin, and particularly, so-called fiber placement machines for applying a wide band formed of a plurality of resin pre-impregnated fibers.

These fiber placement machines, such as described in patent document WO2006/092514 typically comprise a fiber placement head and a system for moving the fiber application head. Typically, the fiber placement head includes a compacting roller for contacting the mold so as to apply the pre-impregnated fiber band, a guide for guiding fibers in the form of a band over the compacting roller, and a heating system for heating the pre-impregnated fibers.

The compacting roller presses the fiber band against the mold application surface, or against the fiber band or bands deposited beforehand, such that the adhesion of the deposited bands between each other is facilitated, and air trapped between the deposited bands is progressively discharged.

The heating system heats the pre-impregnated fiber band, and/or the mold or the bands already applied upstream of the compacting roller, just before the compacting of the band, so as to at least soften the resin and thus promote the adhesion of the bands between each other. Generally, the band heating system provides at least the heating of the band just before its compacting.

In order to ensure a substantially uniform compacting over the entire width of the band, the fiber placement head advantageously comprises a compacting roller able to adapt to the application surface, and preferably, a compacting roller made of a flexible material, which is elastically deformable, generally, an elastomeric material.

In the case of thermosetting resins, the pre-impregnated fibers are just heated to be softened, typically at temperatures of about 40° C. At these temperatures, an elastomeric material flexible roller may advantageously be used. After applying a plurality of layers of superimposed bands, the resulting part is vacuum hardened, through polymerization, by passing it within a furnace, generally an autoclave furnace.

In the case of thermoplastic resins, the pre-impregnated fibers have to be heated at higher temperatures, at least up to the resin melting temperature, that is, of about 200° C. for nylon type resins, and of about 400° C. for PEEK type resins. A hardening operation, called consolidation operation, of the resulting part is advantageously carried out thereafter by passing it within a furnace.

The heating carried out during the application of the band may be implemented through a laser type heating system so as to obtain a concentrated and sharp heating. Owing to the high heating temperatures, the fiber placement heads are provided with heat resistant metallic compacting rollers which may also be cooled from inside via a waterway.

To adapt to the profile of the application surface, there have been proposed segmented metallic compacting rollers, comprising several independent roller segments mounted abreast on a same axis, each segment being independently and radially movable, and being elastically biased against the application surface. Nevertheless, the structure of such segmented metallic rollers and their implementation proved to be complex.

Flexible rollers formed from a so called high temperature elastomeric material, including a heat stabilizer, have also been tested. Nevertheless, these rollers proved to be unsatisfactory for the implementation of thermoplastic resins.

To make it possible to use a flexible roller at the operating temperatures of the thermoplastic resins, there has been proposed, notably in patent document FR 2 878 779, a head provided with two compacting rollers with a heating system acting between both rollers and outputting a heat radiation substantially perpendicular to the band, between both rollers. Such a dual roller head exhibits a greater encumbrance inhibiting fiber deposition on certain application surface profiles. Moreover, the heating of the bands deposited beforehand for their adhesion through welding to the newly applied band is only made through thermal conduction, which constitutes a restrictive factor for the fiber application speed.

### SUMMARY OF THE INVENTION

The present invention is aimed to provide a solution overcoming the aforementioned drawbacks, particularly, making it possible to implement a wide variety of resins, ranging from thermosetting to thermoplastic ones, with a substantially uniform compacting of the applied band and which can be designed and made easily.

To this end, an embodiment of the present invention proposes a fiber application machine for the production of parts made of composite materials comprising:
a compacting roller for applying on an application surface a band formed of at least a resin pre-impregnated flat fiber, preferably formed of a plurality of resin pre-impregnated flat fibers;
a heating system able to emit a heat radiation towards the band, just before the compacting thereof by the compacting roller;

the compacting roller including a cylinder made of an elastically deformable flexible or non-rigid material, and substantially transparent to the heat radiation.

According to an embodiment of the invention, the machine comprises a compacting roller substantially transparent to the heat radiation emitted by the heating system. It is meant herein, by material “substantially transparent to heat radiation”, a material exhibiting a low absorbance in the wavelength or wavelengths of the heat radiation.

Such a compacting roller makes it possible to avoid a high heat build-up of the compacting roller over its entire thickness owing to the heat radiation of the heating system directed towards the compacting roller. A compacting roller heat build-up according to an embodiment of the invention occurs on surface via thermal conduction, as it contacts the heated band. The cancellation of a high heat build-up of the roller due to the heat radiation directed towards the roller, which seems to be the cause of the rapid thermal degradation of the flexible compacting rollers of the prior art, makes it possible to obtain a thermally stable, flexible compacting roller which can be used for the application of resin pre-impregnated fibers, particularly, thermoplastic resins.

In the case of fiber placement, the machine typically comprises cutting apparatus making it possible to individually cut the fibers upstream of the compacting roller and rerouting apparatus, disposed upstream of the cutting apparatus, for rerouting each fiber that has just been cut towards the compacting roller so as to be able to stop and resume the band application at any time, as well as varying the applied band width. When the width of the applied band is reduced, for example, of only 10 fibers for a 16 or 32 fibers-type placement head, the roller directly receives the heat radiation, with no fibers interposed between the heat source and the roller. The compacting roller according to an embodiment of the invention makes it possible to avoid the high heat build-up due to this direct heat radiation, which is apparently the cause of the rapid degradation of the prior art flexible compacting rollers.

The machine according to an embodiment of the invention which includes a compacting roller of simple design, makes it possible to use a wide range of thermosetting or thermoplastic resins in conjunction with a wide variety of fibers, synthetic or natural, hybrid or non hybrid, particularly, fibers which are commonly used in the composite materials field, such as glass fibers, carbon, quartz and aramid fibers.

The heating system emits an infrared radiation which presents a wavelength or wavelengths between 780 nm and 1500 nm, and the elastically deformable material exhibits a low absorbance of at least in the wavelength range between 780 nm and 1500 nm. Preferably, the heating system emits an infrared radiation of which the wavelength or wavelengths are between 850 nm and 1100 nm.

According to one embodiment, the flexible material is an elastomeric material. Preferably, the flexible material is a silicone or polysiloxane, or a polyurethane, preferably a silicone.

According to one embodiment, the flexible material is the translucent silicone elastomer sold under the commercial denomination Silastic T-4.

According to one embodiment, the compacting roller comprises a rigid central tube, and the flexible material cylinder is coaxially assembled on the tube. The central tube is made of metal and can be of cylindrical cross-section, for example, and is intended for rotationally mounting the roller on a support structure of the machine.

According to one embodiment, the compacting roller comprises an anti-adherent external layer covering said flexible material cylinder, advantageously an anti-adherent film, such as a PTFE (polytetrafluoroethylene) film, which is for example thermally retracted on the cylinder. PTFE is well known by the DuPont brand name Teflon®.

According to one embodiment, the heating system is a laser-type system, particularly laser diodes, a YAG laser type or a fiber laser type. Alternatively, the heating system may comprise one or more infrared lamps.

According to one embodiment, the machine further comprises a thermal regulation system able to output a gas flux, particularly an air flux, directed towards the compacting roller so as to regulate the temperature of the compacting roller, in particular to cool the compacting roller, from the outside and restrict the surface heat build-up of the roller due to heat conduction.

The present invention is also aimed to provide a compacting roller such as previously described, for a fiber application machine, particularly comprising a flexible material cylinder substantially transparent to heat radiations of which wavelengths are comprised between 780 nm and 1500 nm, particularly between 850 nm and 1100 nm.

### BRIEF DESCRIPTION OF THE DRAWINGS

The invention will be better understood, and other aims, details, features and advantages will become more apparent from the following detailed explanatory description of a currently preferred particular embodiment of the invention, with reference to the accompanying schematic drawings in which:

FIG. 1 is a schematic side view of a fiber application head according to an embodiment of the invention, comprising a compacting roller and a heating system; and

FIG. 2 is a perspective schematic view of a compacting roller according to the invention.

### DETAILED DESCRIPTION

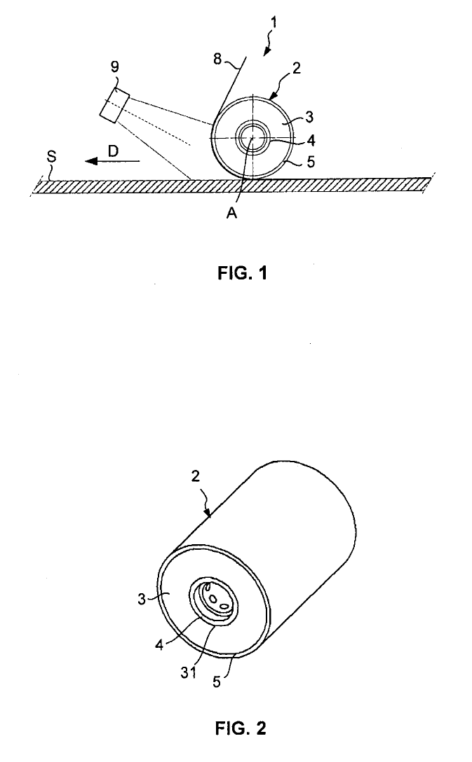

With reference to FIG. 1, the fiber application machine comprises an application head 1 for applying a band 8 of resin pre-impregnated fibers, the head including a compacting roller 2 which is rotationally mounted about an axis A on a support structure (not shown) of the head, the head being mounted by the support structure at the end of a moving system, for example, a robot wrist-joint.

The head further comprises a heating system 9 also mounted on the support structure upstream of the roller with regard to the progress direction D of the application head during the application of fiber band 8 on an application surface S. For example, the heating device is a laser type heating system, of which radiation is directed towards the band, just before the compacting thereof, as well as towards the band or bands deposited beforehand. As illustrated in FIG. 1, the radiation is thus obliquely directed towards the roller so as to heat a band section disposed on the roller, before the compacting thereof by the roller.

In the case of a fiber placement machine, the head comprises a guiding apparatus for guiding the fibers incoming into the head towards the compacting roller 2 in the form of a band of resin pre-impregnated fiber, the fibers of the band being disposed abreast in a substantially butt-jointed fashion. By moving the head via the robot, the compacting roller is brought into contact with the application surface S of a mold for applying the band. With reference to FIG. 2, the compacting roller according to the invention comprises a cylindrical body or cylinder 3 made of a flexible material elastically deformable, by compression, which is substantially transparent to the radiation emitted by the heating system. The cylinder exhibits a cylindrical central passage 31 for its assembly on a support core formed of a cylindrical rigid central tube 4, for example, a metallic tube. Cylinder 3 and central tube 4 are coaxial to each other and rotate integrally with each other. The cylinder is externally coated with an anti-adherent external layer 5, in this case formed of a PTFE film thermally retracted on the external surface of the cylinder.

The flexible material cylinder enables the compacting roller to adapt to the curvature variations of the application surface and to thus apply a substantially uniform pressure on the entire deposited band. The rigid tube makes it possible to rotationally mount the roller on the support structure. The PTFE film, through which the roller contacts the band, restricts the adhesion of the roller to the fibers as well as the fouling of the roller.

For example, the flexible material substantially transparent to heat radiation can be a silicone type elastomeric material, particularly, the silicone elastomer sold by Dow Corning under the commercial denomination Silastic T-4.

The laser type heating system may comprise laser diodes, disposed in one or several rows, emitting a radiation of with wavelength between 880 to 1030 nm for example, an optical fiber laser or an YAG laser emitting at a wavelength of about 1060 nm.

The machine may further comprise a thermal regulation system outputting an air flux, at room temperature for example, of about 20° C. to 30° C., towards the compacting roller, so as to cool it from the outside.

The compacting roller may further be provided with a thermal regulation system, such as described in the French patent application 09 54963, filed by the applicant, on the same day as the French priority date of the present application, and entitled “Fiber application machine comprising a flexible compacting roller with a thermal regulation system”, and filed in the U.S. with application Ser. No. 12/628,449, on the same date as the present application, incorporated herein by reference.

Although the invention has been described in connection with a particular embodiment, it is to be understood that it is in no way limited thereto and that it includes all the technical equivalents of the described means as well as the combinations thereof should these fall within the scope of the invention.

1. A fiber application machine for the production of parts made of composite materials comprising a compacting roller for applying on an application surface, a band formed of at least one resin pre-impregnated flat fiber, and a heating system capable of emitting a heat radiation directed towards the band, said compacting roller comprises a cylinder made of an elastically deformable, flexible material, and substantially transparent to said heat radiation.

2. The fiber application machine according to claim 1, wherein heating system emits infrared radiation wavelength within the range of 780 nm and 1500 nm.

3. The fiber application machine according to claim 2, wherein said heating system emits an infrared radiation wavelength with the range of 850 nm and 1100 nm.

4. The fiber application machine according to claim 1, wherein said flexible material is an elastomeric material.

5. The fiber application machine according to claim 4, wherein said flexible material is a silicone or a polyurethane.

6. The fiber application machine according to claim 5, wherein said flexible material is the translucent silicone elastomer sold under commercial denomination Silastic T-4.

7. The fiber application machine according to claim 1, wherein said compacting roller comprises a rigid central tube on which said flexible material cylinder is coaxially assembled.

8. The fiber application machine according to claim 1, wherein said compacting roller comprises an external anti-adherent layer coating said flexible material cylinder.

9. The fiber application machine according to claim 1, wherein said heating system is a laser type system.

10. The fiber application machine according to claim 1, wherein said machine further comprises thermal regulation means able to output a gas flux directed towards the compacting roller, so as to regulate the temperature of said compacting roller from outside.
